(19) United States
(12) Patent Application Publication
(10) Pub. No.: US 2023/0322247 A1
(43) Pub. Date: Oct. 12, 2023

(54) METHOD AND DRIVING CONTROL SYSTEM FOR UTILIZING REGION-SPECIFIC DRIVING HABITS FOR THE CONTROL OF A MOTOR VEHICLE

(71) Applicants: Hyundai Motor Company, Seoul (KR); Kia Corporation, Seoul (KR)

(72) Inventors: Serkan Duralti, Groß-Zimmern (DE); Lukas Gaß, Mainz (DE)

(21) Appl. No.: 17/894,676

(22) Filed: Aug. 24, 2022

(30) Foreign Application Priority Data
Apr. 6, 2022 (DE) 102022203405.8

(51) Int. Cl. B60W 50/08; G07C 5/00

(52) U.S. Cl. CPC B60W 50/085; G07C 5/008; B60W 2554/4046; B60W 2556/45; B60W 2540/30; B60W 2540/22; B60W 2050/0088

(57) ABSTRACT

Methods and driving control systems for utilizing region-specific driving habits for the control of a motor vehicle are provided. A method includes determining a current position of the motor vehicle, and assessing, by a driving control unit of the motor vehicle, whether region-specific driving habits exist in a geographical area around the current position of the motor vehicle, wherein the region-specific driving habits characterize non-statutory driving rules followed by residential traffic participants within the respective geographical area. The method further includes and at least one of: adapting a vehicle configuration of the motor vehicle according to the assessed region-specific driving habits within the respective geographical area; and providing, with the driving control unit, region-specific control assistance to a driver of the motor vehicle and/or region-specific control commands to the motor vehicle based on the assessed region-specific driving habits within the respective geographical area.

### CROSS-REFERENCE TO RELATED APPLICATION

This application claims, under 35 U.S.C. § 119(a), the benefit of German Patent Application No.102022203405.8, filed on Apr. 6, 2022, the disclosure of which is incorporated herein by reference in its entirety.

### BACKGROUND

### Technical field

Embodiments of the present disclosure pertain to a method and a driving control system for utilizing region-specific driving habits for the control of a motor vehicle, as well as to a motor vehicle having such a driving control system.

### Description of the Related Art

Region-specific driving habits develop according to country, region, and mentality. This is especially the case in Europe. For nonresident drivers unfamiliar with respective local habits, this may cause inconvenience, stress, and/or confusion, and may even be affect safety, since these habits are often handled by local drivers as unwritten laws.

Currently, it is difficult, if not almost impossible, from a practical point of view for external drivers to get information about all regional driving habits from the public authorities. In addition, these habits are often not tied to national law and national borders, which makes identification of such habits and driver support even more challenging. One example is the widespread usage of the left indicator in roundabouts in Spain and other southern European countries, which is not prescribed by law yet is nevertheless followed by most drivers in these regions.

U.S. Pat. No. 10,535,260 B2 describes a vehicle configured to request official road rules information from local jurisdiction information servers, and compiles the road rules information into compiled rules for a current location of the vehicle. The vehicle is also configured to identify an occurrence of a road situation and determine whether a driving behavior is in conflict with a compiled rule corresponding to the road situation for the current location of the vehicle. When a conflict is detected, the vehicle may invoke an interaction associated with the compiled rule to address the driving behavior.

Hence, there is a need to find solutions that allow adaption of driving behavior to any kind of local custom in a straightforward manner.

### SUMMARY

Embodiments of the present disclosure provide a method, a driving control system, and a motor vehicle.

According to an exemplary embodiment of the present disclosure, a method for utilizing region-specific driving habits for the control of a motor vehicle is provided. The method includes: determining, by a navigation system of the motor vehicle, a current position of the motor vehicle; assessing, by a driving control unit of the motor vehicle, whether region-specific driving habits exist in a geographical area around the current position of the motor vehicle, wherein the region-specific driving habits characterize non-statutory driving rules followed by residential traffic participants within the respective geographical area; and at least one of: adapting a vehicle configuration of the motor vehicle according to the assessed region-specific driving habits within the respective geographical area; and providing, with the driving control unit, region-specific control assistance to a driver of the motor vehicle and/or region-specific control commands to the motor vehicle based on the assessed region-specific driving habits within the respective geographical area.

According to another exemplary embodiment of the present disclosure, a driving control system for utilizing region-specific driving habits for the control of a motor vehicle is provided. The driving control system includes: a navigation system configured to determine a current position of the motor vehicle; and a driving control unit configured to assess whether region-specific driving habits exist in a geographical area around the current position of the motor vehicle, wherein the region-specific driving habits characterize non-statutory driving rules followed by residential traffic participants within the respective geographical area, and wherein the driving control unit is further configured to at least one of: adapt a vehicle configuration of the motor vehicle according to the assessed region-specific driving habits within the respective geographical area; and provide a region-specific control assistance to a driver of the motor vehicle and/or region-specific control commands to the motor vehicle based on the assessed region-specific driving habits within the respective geographical area.

According to yet another exemplary embodiment of the present disclosure, a motor vehicle is provided which includes a driving control system according to the present disclosure.

According to an exemplary embodiment of the present disclosure, the driving control unit may be configured to wirelessly retrieve a dataset characterizing the region-specific driving habits from a data storage.

According to an exemplary embodiment of the present disclosure, the driving control unit may be configured to determine whether the driver of the motor vehicle is regionally experienced in driving in a geographical area around the current position of the motor vehicle based on user data of the driver. The method may correspondingly include determining whether the driver of the motor vehicle is regionally experienced in driving in a geographical area around the current position of the motor vehicle based on user data of the driver.

According to an exemplary embodiment of the present disclosure, the driving control unit may be configured to record driving data of the motor vehicle characterizing region-specific driving habits when the driver is determined to be regionally experienced. The method may correspondingly include recording driving data of the motor vehicle characterizing region-specific driving habits when the driver is determined to be regionally experienced.

First, it may be be determined if the vehicle is driven by a locally experienced driver and/or whether the vehicle is already adapted to the local driving habits. In other words, the vehicle and/or the driver may be first classified with regards to their experience/configuration with respect to local customs. If this is answered in the affirmative, the information gathered during driving may be be used to establish a data pool for this specific region including any relevant information with regards to local driving behavior. By determining the driver's experience independently from the vehicle, it may be ensured that a temporary change of driving habits by rental customers or tourists, for example, does not affect the identification of regional driving habits.

The driving data may be recorded by the vehicle, wherein a main focus may be on driver input variables (e.g. indicator usage, position on lane, distance to vehicle in front, acceleration/braking, etc.) and context data (e.g. road type, traffic light monitoring, speed limit, surrounding vehicle dynamics).

According to an exemplary embodiment of the present disclosure, the driving control unit may be configured to wirelessly communicate the driving data to a computing entity where the driving data of individual motor vehicles are merged and processed as fleet data.

When a driver is classified as experienced regional driver, the respective driving data may be recorded by the vehicle and used for the identification of region-specific driving habits. To this end, the data may be collected across a fleet of vehicles. The data may first be filtered by the vehicle before sending it to the computing entity (and/or to a data storage associated with the computing entity) to lower the data traffic. By obtaining feedback about relevant and irrelevant or less relevant data from analysis algorithms run on the computing entity, the filter settings may be kept up-to-date in order to filter relevant data the most efficient way.

For example, recording and pre-processing of vehicle data may be run via edge computing or other distributed computing solutions. The data may then be merged and analyzed in a cloud computing environment in order to identify regional driving behavior. The data may be checked for conformity with regulations and laws and then get stored for feedback to other vehicles.

According to an exemplary embodiment of the present disclosure, the fleet data may be analyzed based on machine learning algorithms to determine regional driving habit clusters defining localized geographical areas with respective region-specific driving habits.

Data from individual vehicles may be merged and processed as fleet data, which may then be analyzed based on machine learning, e.g. unsupervised machine learning, to determine regional driving habit clusters. The clusters may be defined by existing borders (e.g. federal states/nations) or initially undefined boundaries (different driving style in the mountains than on flat land, for example). The basis for such a cluster may always be the regional driving behavior and not an official border. It is to be understood, however, that other machine learning techniques may be employed, alone and/or in conjunction with other machine learning techniques, depending on the particular use case at hand.

Unsupervised learning, also known as unsupervised machine learning, uses machine learning algorithms to analyze and cluster unlabeled datasets. These algorithms discover hidden patterns or data groupings without the need for human intervention. The number of clusters may not be pre-defined but determined dynamically. Such an algorithm may identify similarities and differences of the data to discover clusters. Its ability to discover similarities and differences in information makes it an ideal solution for exploratory data analysis such as customer segmentation or the identification of behavior patterns (e.g. driving style).

According to an exemplary embodiment of the present disclosure, the driving control unit may be configured to monitor a cognitive load of the driver and to adapt the region-specific control assistance based on the monitored cognitive load of the driver. The corresponding method may thus correspondingly include monitoring a cognitive load of the driver, wherein the driving control unit may be configured to adapt the region-specific control assistance based on the monitored cognitive load of the driver.

In this regard, the system may be configured to determine when and how to supply the information to the driver with the least distraction. For example, when the cognitive load of the driver is determined to be low (small risk of distraction), the driver may be informed about the regional driving behavior and the adapted vehicle settings (e.g. via HUD or TTS or the like). Prior to publishing region-specific behavior information to the driver via various visual and/or audible methods (including, e.g., a companion app or the like), the best timing for the driver's absorption capacity, mental condition and environmental state (by e.g. traffic volume, pedestrians nearby, active phone calls, an advanced driver assistance system (ADAS) usage) may be checked by suitable sensor systems.

The present disclosure will be explained in greater detail with reference to exemplary embodiments depicted in the drawings as appended.

### BRIEF DESCRIPTION OF THE DRAWINGS

In order to help more full understanding of the drawings used in the detailed description of the present disclosure, a brief description of each drawing is provided.

FIG. 1 schematically depicts a driving control system for a motor vehicle according to an embodiment of the disclosure.

FIG. 2 shows a flow diagram of a method for utilizing region-specific driving habits for the control of the motor vehicle of FIG. 1.

### DETAILED DESCRIPTION

In order to fully understand the present disclosure and the object achieved by the implementation of the present disclosure, reference should be made to the accompanying drawings illustrating the exemplary embodiment of the present disclosure and the contents described in the accompanying drawings.

It is understood that the term “vehicle” or “vehicular” or other similar term as used herein is inclusive of motor vehicles in general such as passenger automobiles including sports utility vehicles (SUV), buses, trucks, purpose built vehicles (PBVs), various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present disclosure will be described in detail by describing the exemplary embodiment of the present disclosure with reference to the accompanying drawings. In the following description of the exemplary embodiment, a detailed description of known configurations or functions incorporated herein will be omitted when it is judged that the detailed description may make the subject matter of the present disclosure unclear. Like reference numerals presented in each drawing designate like elements throughout the specification.

According to an exemplary embodiment of the present disclosure, systems and methods configured for automatically factoring in information about regional driving habits, which may not be legally prescribed and which may be specific to localized geographic regions not defined by national borders, in order to avoid misunderstandings, uncomfortable situations, and/or traffic hazards when driving in unfamiliar regions where the local driving behavior departs from familiar rules. To this end, the driving experience of the local community may be provided to a nonresident driver by adapting the content of an advanced driver assistance system (ADAS). Similarly, the configuration and/or driving commands of an autonomous and/or automatic vehicle may be adapted to the driving habits of the current surroundings. In this vein, road safety for vehicle occupants and other traffic participants may be increased and unnecessary disruption of the traffic flow may be avoided when driving through unfamiliar regions. The systems and methods of the present disclosure will generally enable fast familiarization with the specific local traffic conditions and will therefore provide benefits for driver satisfaction.

The presently followed approach is highly flexible, as it clusters regional driving habits by their occurrence, and is not limited to existing static boundaries such as, for example, state and/or national borders. Instead, the local customs may be clustered according to basically arbitrary small regions (of a specific country, for example). These regions may also cross and/or transcend national borders and are thus basically not limited to any existing official boundaries.

The systems of the present disclosure may be configured to access a centralized (e.g. a server, centralized cloud storage) or decentralized (e.g. distributed cloud network) data storage in order to keep the vehicle and a driver up-to-date at any time with regards to local driving customs. For example, when a vehicle enters a new region characterized by specific driving habits, one or more of the systems of the present disclosure may be configured to provide region-specific driving guidance to the driver based on the wirelessly acquired data. Additionally, or alternatively, the vehicle configuration may be adapted to fit the region-specific driving habits. Moreover, driving commands of a self-driving vehicle may be adapted accordingly.

According to various embodiments, it may be determined whether a driver is a nonresident, foreign, and/or locally unexperienced driver. It is to be understood that, additionally or alternatively, it may also be checked whether the vehicle is correctly configured to the driving habits of the region currently being passed through. With regards to the vehicle, an automatic classification may be employed depending, e.g., on a travel/location history of the vehicle. The driver's regional experience on the other hand may be determined based on various user data including but not limited to a vehicle/driver driving history (e.g. private car with known driver), historic smartphone location data (e.g. google maps timeline function), smartphone language settings, vehicle booking information in case rental/shared vehicles (e.g. driver nationality) and so on.

In this regard, user data may comprise personal information of the driver, a driving history of the driver and/or the motor vehicle, smartphone location data and/or language settings. Depending on an experience level of the driver, the region-specific guidance of the system may be adapted accordingly. For example, an experienced driver may not need any guidance with regards to the local customs. Thus, the system may be configured to check in a first step after entering a new region with changed local driving habits if the driver is already familiar with those customs and thus regionally experienced. A vehicle configuration does not necessarily have to be adapted when crossing such a border, e.g. in case the vehicle is already equipped with the required settings and driving rules.

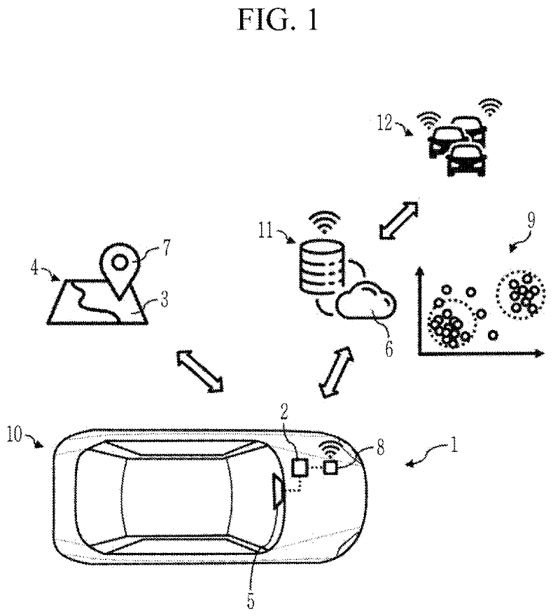

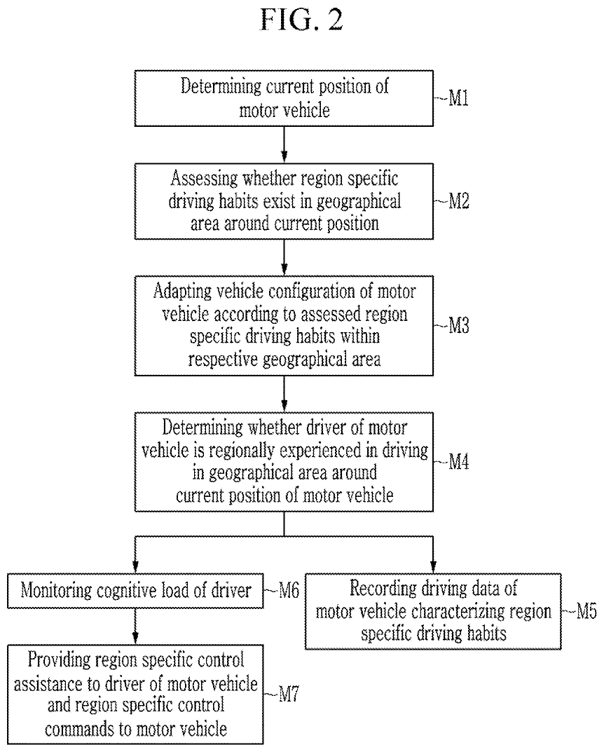

Referring now to FIGS. 1-2, a driving control system 1 for a motor vehicle 10 is schematically depicted (FIG. 1), according to an exemplary embodiment of the present disclosure, and a flow diagram of a method M for utilizing region-specific driving habits for the control of the motor vehicle 10 of FIG. 1 is provided (FIG. 2).

The driving control system 1 may be provided and configured to utilize region-specific driving habits for the control of a motor vehicle 10 and can be applied both to manual and autonomous/automatic driving. The basic idea behind the system 1 is to collect and analyze vehicle fleet data to identify regional driving habits, which are then sent to non-residential drivers not familiar with local customs and/or to autonomous vehicles in order to avoid misunderstandings or accidents in unfamiliar driving situations. Regional clusters as well as driving habits may be determined by machine learning algorithms and are not limited to pre-defined (e.g. national) borders or driving situations. Drivers may be automatically classified as regionally experienced or unexperienced (or inexperienced) drivers. Thus, they can either be data source or receiver of the regional driving habit information, as will be explained in the following.

The system 1 comprises a navigation system 4 configured to determine and track a current position 7 of the motor vehicle 10.

The system 1 further comprises a driving control unit 2 configured to assess whether region-specific driving habits exist in a geographical area 3 around the current position 7 of the motor vehicle 10. Such a geographical area 3 within the present meaning is defined by the respective driving habits and hence is not limited to national or federal or otherwise pre-defined borders or boundaries. Consequently, such geographical areas 3 may traverse or cross national borders and may be arbitrary localized territories.

Region-specific driving habits within the present meaning characterize non-statutory driving rules that are not fixed by law but nevertheless are consistently followed by the majority of residential traffic participants within the respective geographical area 3. For example, in some south European regions, it is custom to activate the left indicator when driving within a roundabout in order to show that one continues to drive inside the roundabout. This is a custom that is not necessarily required by the respective laws and traffic regulations (e.g. in Spain). However, it may create an unclear situation for drivers not familiar with the habit and may not only be inconvenient but also pose a safety risk. There is thus a need to harmonize such inhomogeneous traffic customs for all traffic participants.

To this end, the present system 1 assesses whether region-specific driving habits exist. To this end, the driving control unit 2 may be configured to wirelessly retrieve a dataset characterizing the region-specific driving habits from a data storage 6 (e.g. a cloud storage), e.g. by means of a communication unit 8.

Prior to this, the driving control unit 2 may be configured to determine whether the driver of the motor vehicle 10 is regionally experienced in driving in a geographical area 3 around the current position 7 of the motor vehicle 10 based on user data of the driver. Such user data may comprise, for example, personal information of the driver, a driving history of the driver and/or the motor vehicle 10, smartphone location data, one or more language settings, and so on.

In case local driving habits exist and the driver is inexperienced, the driving control unit 2 may be further configured to provide a region-specific control assistance to the driver of the motor vehicle 10 according to the assessed region-specific driving habits within the respective geographical area 3 (in case of manual driving), e.g. via a user driver interface 5. This data may be received via the mentioned wireless interface, e.g. of an in-built telematics control unit, and may, for example, be provided to the electronic systems installed in the driver interface 5, for example a dashboard (e.g. AVN, IP-Cluster or HUD) of the vehicle 10, or a companion app for post-driving notification.

Prior to release of data including information about driving habits of each single region to be supplied, the best timing for the vehicle driver's absorption capacity, mental condition and environmental states (by e.g. traffic volume, pedestrians nearby, active phone calls, ADAS usage) may be checked before publishing region-specific behavior information to the driver via various visual or audible methods (incl. companion app). To this end, the driving control unit may be configured to monitor a cognitive load of the driver, e.g. by means of various sensors providing information about the driver and/or the environment, and adapt the region-specific control assistance based on the monitored cognitive load of the driver.

Regional driving behavior guidance may be provided in an understandable way by using visual representation, notifications and/or audible announcements to attract the driver's attention to the habitual behavior in the traffic of the specific area. It is to be understood that the corresponding data does not necessarily have to be provisioned during a trip but may also be provided before or after a trip.

In a similar vein, the system 1 may also be configured to initiate reconfiguration of the vehicle 10. In this case, the vehicle 10 may be be classified as “new to the region” by comparing the current vehicle location with the location history (entering a new regional behavior area), for example. Then a regionally optimized vehicle configuration may be loaded, e.g. adapted to ADAS preferences.

Moreover, in case of a self-driving and/or autonomous vehicle, the system 1 may be configured to adapt the control commands for the vehicle 10 adequately, e.g. for a steering system, a drive train etc. of the vehicle 10 (not shown).

In the other case that the driver is determined to be regionally experienced and/or the vehicle is already configured to the local driving rules, the driving control unit 2 may be configured to record driving data of the motor vehicle 10 characterizing the region-specific driving habits.

The driving control unit 2 may further be configured to wirelessly communicate the driving data to a computing entity 11 (e.g. an edge and/or cloud computing infrastructure) where the driving data of individual motor vehicles 10 are merged and processed as fleet data.

These fleet data may then be analyzed based on machine learning algorithms, e.g. unsupervised machine learning, to determine regional driving habit clusters defining localized geographical areas 3 with respective region-specific driving habits. These, in turn, may then be stored in the data storage 6 for future usage by other vehicles.

In this respect, the legal conformity of the identified driving style may be cross-checked first before saving and publishing regional driving behavior hints and vehicle settings to other vehicles. Driving behavior that punishes regulation may not be saved and not sent to other drivers.

The method M in FIG. 2 correspondingly comprises, under M1, determining the current position 7 of the motor vehicle 10 and, under M2, assessing whether region-specific driving habits exist in a geographical area 3 around the current position 7. When that is the case, then the method M continues, under M3, with adapting a vehicle configuration of the motor vehicle 10 according to the assessed region-specific driving habits within the respective geographical area 3. In a manually driven vehicle 10, the method M may then comprise, under M4, determining whether the driver of the motor vehicle 10 is regionally experienced in driving in a geographical area 3 around the current position 7 of the motor vehicle 10 based on user data of the driver. When this is answered in the affirmative, the method M continues, under M5, with recording and analyzing driving data of the motor vehicle 10 characterizing region-specific driving habits. Otherwise, the method M continues, under M6, with monitoring a cognitive load of the driver and, under M7, with providing region-specific control assistance to the driver of the motor vehicle 10 , wherein the driving control unit 2 adapts the region-specific control assistance based on the monitored cognitive load of the driver. In a self-driving vehicle 10, corresponding one or more region-specific control commands may be provided to the motor vehicle 10 based on the assessed region-specific driving habits within the respective geographical area 3.

As a result, embodiments of the present disclosure thus open up the possibility to integrate local non-statutory driving habits in the driver guidance of an ADAS system. Similarly, autonomous vehicles may learn from local driving habits to better integrate regional driving styles.

In the foregoing detailed description, various features are grouped together in one or more examples with the purpose of streamlining the disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The embodiments were chosen and described in order to explain the principles of the present disclosure and its practical applications, to thereby enable others skilled in the art to utilize the present disclosure and various embodiments with various modifications as are suited to the particular use contemplated.

What is claimed is:

1. A method for utilizing region-specific driving habits for control of a motor vehicle, the method comprising:
determining, by a navigation system of a motor vehicle, a current position of the motor vehicle;
assessing, by a driving control unit of the motor vehicle, whether region-specific driving habits exist in a geographical area around the current position of the motor vehicle, wherein the region-specific driving habits characterize non-statutory driving rules followed by residential traffic participants within the respective geographical area; and
at least one of:
adapting a vehicle configuration of the motor vehicle according to the region-specific driving habits within the respective geographical area; and
providing, with the driving control unit:
region-specific control assistance to a driver of the motor vehicle; and/or
region-specific control commands to the motor vehicle based on the
assessed region-specific driving habits within the respective geographical area.

2. The method according to claim 1, further comprising wirelessly retrieving, by the driving control unit from a data storage, a dataset characterizing the region-specific driving habits.

3. The method according to claim 1, further comprising determining, with the driving control unit, whether the driver of the motor vehicle is regionally experienced in driving in a geographical area around the current position of the motor vehicle, based on user data of the driver.

4. The method according to claim 3, wherein the user data comprises at least one of:
personal information of the driver;
a driving history of the driver and/or the motor vehicle;
smartphone location data; and
one or more language settings.

5. The method according to claim 1, further comprising recording driving data of the motor vehicle characterizing region-specific driving habits when the driver is determined to be regionally experienced.

6. The method according to claim 5, further comprising:
wirelessly communicating, to a computing entity, the recorded driving data; and
merging and processing driving data of individual motor vehicles as fleet data.

7. The method according to claim 6, further comprising analyzing the fleet data based on machine learning algorithms to determine regional driving habit clusters defining localized geographical areas with respective region-specific driving habits.

8. The method according to one of the claim 1, further comprising:
monitoring a cognitive load of the driver; and
adapting, using the driving control unit, the region-specific control assistance based on the monitored cognitive load of the driver.

9. A driving control system for utilizing region-specific driving habits for control of a motor vehicle, comprising:
a navigation system configured to determine a current position of a motor vehicle; and
a driving control unit configured to assess whether region-specific driving habits exist in a geographical area around the current position of the motor vehicle,
wherein:
the region-specific driving habits characterize non-statutory driving rules followed by residential traffic participants within the respective geographical area, and
the driving control unit is further configured to at least one of:
adapt a vehicle configuration of the motor vehicle according to the region-specific driving habits within the respective geographical area; and
provide:
a region-specific control assistance to a driver of the motor vehicle; and/or
one or more region-specific control commands to the motor vehicle based on the assessed region-specific driving habits within the respective geographical area.

10. The driving control system according to claim 9, wherein the driving control unit is configured to wirelessly retrieve a dataset characterizing the region-specific driving habits from a data storage.

11. The driving control system according to claim 9, wherein the driving control unit is configured to determine whether the driver of the motor vehicle is regionally experienced in driving in a geographical area around the current position of the motor vehicle based on user data of the driver.

12. The driving control system according to claim 11, wherein the user data comprises at least one of:
personal information of the driver;
a driving history of the driver and/or the motor vehicle;
smartphone location data; and
language settings.

13. The driving control system according to claim 9, wherein the driving control unit is configured to record driving data of the motor vehicle characterizing region-specific driving habits when the driver is determined to be regionally experienced.

14. The driving control system according to claim 13, wherein the driving control unit is configured to wirelessly communicate the driving data to a computing entity, wherein driving data of individual motor vehicles are merged and processed as fleet data.

15. The driving control system according to claim 14, wherein fleet data are analyzed based on machine learning algorithms to determine regional driving habit clusters defining localized geographical areas with respective region-specific driving habits.

16. The driving control system according to claim 9, wherein the driving control unit is configured to:
monitor a cognitive load of the driver; and
adapt the region-specific control assistance based on the monitored cognitive load of the driver.

17. A motor vehicle with a driving control system according to claim 9.
